(19) United States
(12) Patent Application Publication
(10) Pub. No.: US 2010/0095225 A1
(43) Pub. Date: Apr. 15, 2010

(54) INTERACTIVE SYSTEM AND METHOD

(76) Inventors: Daniel Langlois, Montreal (CA); Guy Labelle, Montreal (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/517,416

(22) PCT Filed: Oct. 26, 2007
(86) PCT No.: PCT/CA07/01926

§ 371 Date: Jul. 17, 2009

(30) Foreign Application Priority Data
Oct. 26, 2006 (CA) 2565757

(51) Int. Cl. G06F 3/048; G06F 17/30

(52) U.S. Cl. 715/757

(57) ABSTRACT

A system and method to interactively connect real entities (object or person) to virtual entities or representation thereof and share information therebetween is provided. Moreover, the virtual entities are linked, via a network and/or via a wireless network-enabled device to their real life counterparts. Hence, the system allows, via the network and/or wireless network-enable devices, the gathering of information related to the real entities and the virtual representations thereof. In another aspect of the invention, the system and method allow interactions between the operator and/or sponsor of a real life or virtual event and real life and/or virtual participants therein.

### CROSS-REFERENCE TO RELATED APPLICATIONS

The present patent application claims the benefits of priority of commonly assigned Canadian Patent Application No. 2,565,757, entitled “System for Linking Real Entities to Virtual Entities Thereof” and filed at the Canadian Patent Office on Oct. 26, 2006.

### FIELD OF THE INVENTION

The present invention generally relates to interactive systems and methods for networking and for transmission of information relating to events and/or users, real and/or virtual.

### BACKGROUND OF THE INVENTION

Since the rise of the now ubiquitous Internet, people have started to interact more and more online with each other via functionalities such as e-mail, chat, instant messaging and videoconferencing. Using the Internet as a means to connect with others, some people have started to create a virtual character or identity of themselves.

Moreover, with the progress of networking, computer and graphical processing technologies, it has now become possible to push the level realism to new heights. Hence, Internet users can now even create graphical representations of themselves in the form of virtual avatars. Then, via their avatars, people can interact with others in virtual environments (sometimes referred to as virtual worlds) and/or massively multiplayer role playing games. In these virtual worlds, the avatars can interact with each other and/or with objects as if in the real world. Still, other less realistic forms of avatar or virtual representation are also possible.

However, the avatars that people create of themselves in these virtual environments are generally physically and electronically disconnected from their real life counterparts. Though this dichotomy between their real selves and their virtual avatars is sometimes wished for, it remains that for a lot of people, continuity between the real world and the virtual world(s) in which they evolve via their avatar(s) would be interesting and even beneficial.

Spectator events have become a multibillion dollar a year business throughout the world. Rather than merely watching events on television or on a computer, fans are willing to attend such events live in order to enjoy the spontaneity and excitement. However, the opportunities for audience participation and useful or meaningful audience feedback are limited.

Further, participants in events are becoming more and more accustomed to interactivity from their use of computer games to interact in various ways. Accordingly, in order to continue attracting participants to attend these large venues, operators have an incentive to provide participants with an enhanced experience.

The participants also desire to express opinions concerning facilities, sponsors, management and concessions. Being able to voice an opinion would enhance the overall experience. Also, this kind of information can be useful to management by helping it determine the kind of services that participants desire.

There is thus a need for a system and method which obviates the aforementioned shortcomings.

### OBJECTS OF THE INVENTION

Accordingly, a prime object of the present invention is to provide a system and method which allows users and/or event operators and/or event sponsors to share information between themselves and the members of the real life and/or virtual communities to which they are associated in order to create a certain continuity therebetween.

Another object of the present invention is to provide a system which allows an event operator and sponsors associated thereto to use information gathered by participants in future communications with such participants.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The system of the present invention can be advantageously implemented on the Internet or other public or private networks. Accordingly, the system of the present invention preferably comprises a plurality of servers linked to Internet servers whereby information can easily be transferred form one server to another and whereby user and event databases can easily be remotely accessed. The servers preferably comprise databases, distributed or centralized, onto which information about users and events is stored.

The system of the present invention provides means to create communities based on the actions and the participation of users in events, virtual or real. A dynamic profile is created for each user.

Entities Using the System

The system may be used by different entities: users, sponsors and operators. The sponsors are the ones that want to interact with users as a function of their profiles and their membership in certain communities. The operators are the ones that use/operate the system of the present invention. A sponsor may be an operator, but the operator may be an intermediary that uses the system to execute the interaction between the users and the sponsors.

Infrastructure

To operate the system, the system of the present invention preferably comprises a main server, an event server and a wireless network-enabled device of a user. The same computer is preferably used to provide a wireless access on the site of an event and to provide the data related to the event to the users participating in the event.

An event server has all the information related to the corresponding event and the main server has all the user and other information that need to be spread over the network. The main server generally comprises the following items:
Information related to the users;
The applications available for user computers and wireless network-enabled devices;
The content to be displayed to the users.

The main server is also used to maintain a central information database and to manage activities, such as:
Creation of user profiles;
Management of the activities of users (event, community, . . . );
Management of invitations to users;
Management of the points reward system;
Management of the financial reward system;
Management of the service and product offerings;
Transactions with Financial institutions.

Events

During a real life event, a local network, preferably an ad hoc mobile wireless network covering the site where the event, is setup to provide a wireless access, and to send data related to the event to users located on the site. An event server is also used to store data relating to the event, including data relating to event sponsor(s) and their products and services. It is then possible for the user who has agreed to receive data to get messages, applications or information on this specific event, the products and services of the sponsors on his mobile communication device. Some of the wireless network nodes may be transported by a person that can interact with users with interactive means. Wireless nodes can also be integrated in stands or kiosks comprising or not a computer having means to interact with users, such as a touch screen, keyboard, mouse, etc. . . .

According to an aspect of the invention, if an event, real life or virtual, becomes available to users, a notification message may be transmitted to all the users or to a subset thereof as a function of the preferences of such subset of users. The notification message may include information about the event (e.g., where, when, duration, type of activity, participants, interests, etc . . . ). Based on the information included in the notification message, a user may choose to participate in the event. Notification messages are advantageous in that they enable information about the event to be viewed before the full media content of the messages is retrieved.

Following the agreement of the user to receive information related to this event, the user may be asked to subscribe to a community relevant to the event (subject matter, type, sponsor, participant profile, etc . . . ). The profile of the user is then updated and the user may receive invitations to other similar real life or virtual events. He may also receive surveys, questionnaires or product/service offers preferably associated with rewards (gifts, points, discount coupons, money, . . . ).

Profile

For a user, the first step is to create an account or a profile in the global community. This account will include identification information about the user and is stored in a main database located on a main server. Such information preferably also includes particulars of his/her product/service preferences, age, sex, and other useful information. Understandably, the account could contain more or less information. The profile will also contain historical information about user's participation in events and surveys, products/services purchases and software applications used by the user. Finally, in order to facilitate access to the main database and to event databases by the user, the account is most preferably provided with information about a least one electronic, and preferably handheld, wireless network-enabled device that the user usually uses and even carries with him/her. For example, the wireless network-enabled device could be a cellular phone or a pocket PC or other personal digital assistant (PDA). The wireless network-enabled device should preferably be enabled to use a freely accessible bandwidth such as WI-FI, Zigbee or Bluetooth. It is also possible to have a system that recognizes the presence and type of network-enabled device of a user when the user approaches the site of the event. This allows the system operator to choose the most appropriate application format or interface presentation to send to the user. It is understandable that a device such as pocket PC, having higher computing and memory resources, has more possibilities than a standard phone.

A user may participate in a plurality of events and/or activities with the use of a regular computer or with a wireless network-enabled device. He may also subscribe to one or more communities, participate in an event or make purchases of products or services during the event or as a result of an offer made during the event. All these activities and related information are stored in the profile of the user on the main server. The user profile is thus dynamic being updated both by the user and by the system itself.

Rewards

When a user participates in an activity, a real life or virtual event, acts on an offer made during the event, answers a survey or questionnaire, points or another for of reward (gifts, discount coupons, money, . . . ) may be issued to the user. These points may be exchanged or used to buy products or tickets for an event or other services. It may be particularly useful to get the opinion of potential consumers before the commercialisation of products/services. For example, the user may be asked to give an opinion in relation to the various possible colors or designs of a camera or clothing and as a result obtain a rebate for such product.

Communities

Users may be invited to form part of one or more virtual communities having certain common interests. The identification of relevant communities may be based on one or more filtering criteria including, but not limited to, interests listed in the user profile, participation in past events, real life or virtual, typical participant profile, type of requested information, membership in a group having interests compatible with those of the community, etc . . . .

Interactive Means

The interface used with the wireless network-enabled device will vary depending on the type of device. For example, with a pocket PC or other PDA, it is possible to have an application installed on it that has more possibilities than on a standard mobile phone. Thus, the interaction may take the form of applications downloaded during an event, a sms sent to a mobile phone, a web page or other means. The applications may also be installed on a laptop. A stand or kiosk may also be available at the event site to provide an access to the event server and to the main server. Thus, a user may create an account during an event and use the stand or kiosk for related activities. An example of such an interactive means is described in co-pending PCT application no. (to follow), entitled “Contextual Window-Based Interface and Method Therefor”, filed on the same day as the present application.

As specified above and according to an aspect of the invention, users of the system of the invention may be notified of the existence of an event as they approach the site. The proximity of a user's mobile computing device may be determined via any number of location-tracking methods including, but not limited to, Bluetooth beacons, the Global Positioning System (GPS), analysis of wireless network antennae utilization, physical hyperlink technologies such as two-dimensional barcodes or Radio Frequency identification (RFID) tags, or wireless network antenna triangulation. The event data is thus accessible on a plurality of devices, as long as this device is provided with an access to the event server through a connection (for example WI-FI, internet, Bluetooth . . . ).

The features of the present invention, which are believed to be novel, are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a first schematic view of the present invention.

FIG. 2 is a schematic view of the present invention.

FIG. 3 is a schematic view of an embodiment of an interactive system.

FIG. 4 is a schematic view of an embodiment of an event based interactive system allowing an operator of the system to communicate with individual users interested in the event.

FIG. 5 is a schematic view of another embodiment of an interactive communication method allowing an operator of the method to communicate with users of a database containing data related to users stored on a main server.

FIG. 6 is a schematic view of another embodiment of an event based method allowing an operator of the method to add new users interested in the event to an existing database stored on a main server.

FIG. 7 is a schematic view of another embodiment of an event based method allowing new users interested to participate to an event to be added to an existing database stored on a main server.

FIG. 8 is a schematic view of another embodiment of a system for interactively linking a real entity and a corresponding virtual entity thereof.

FIG. 9 is a schematic view of another embodiment of an interactive communication method.

FIG. 10 is a schematic view of another embodiment of an event based interactive communication method allowing an operator of the method to communicate with a plurality of users interested in an event.

FIG. 11 is a schematic view showing the relation between the user, and the operator and/or sponsor.

### DETAILED DESCRIPTION OF A PREFERRED EMBODIMENT

A novel system for linking and connecting real users to other users, real or virtual, events, real life or virtual, communities and their operators and sponsors will be described hereinafter. Although the invention is described in terms of specific illustrative embodiments, it is to be understood that the embodiments described herein are by way of example only and that the scope of the invention is not intended to be limited thereby.

As used herein the word “event” includes the usual meaning of “a social occasion or activity”. However, it also includes many other activities in which a plurality of participants gathers together in one or more sites during a period of time. Therefore a day of shopping at a shopping center or at a given store is included in the concept of “event” within the meaning of this invention.

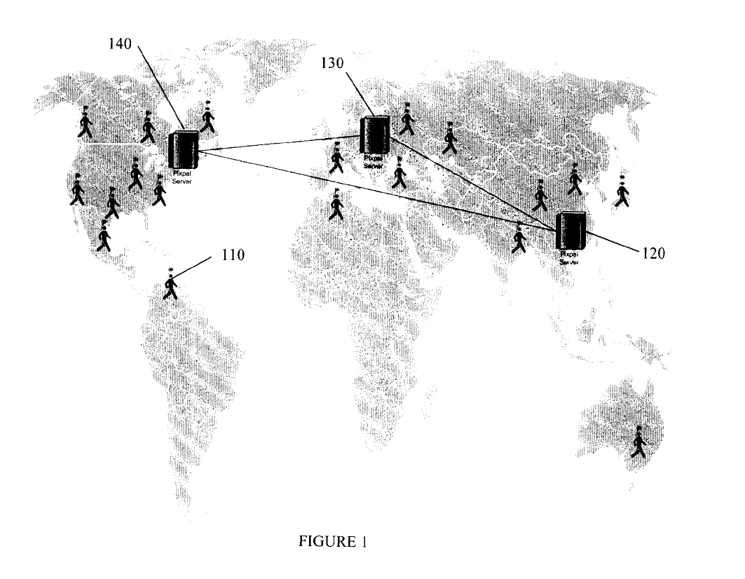

In FIG. 1, the present invention is illustrated on a world map, with main servers 120, 130, 140 and a plurality of computer located in event 110.

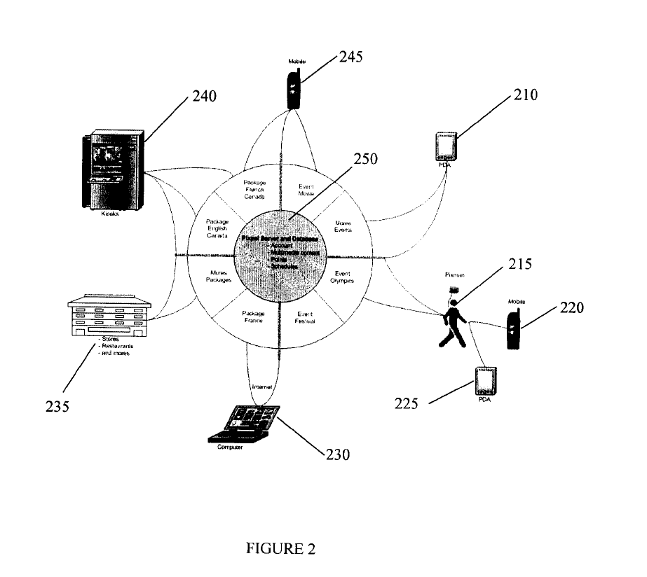

In FIG. 2, the relations between the elements of an embodiment are shown in a schematic view. The mobile 245 and the PDA 210 can receive and/or exchange data with the main server and database 250 through a wireless connection. The computer 230, the stand 240 and the store 235 can receive and/or exchange data with the main server and database 250 through a connection, wireless or not. Finally, the wireless network node which is transported by a person 215, provide a wireless access to electronic devices 220 and 225.

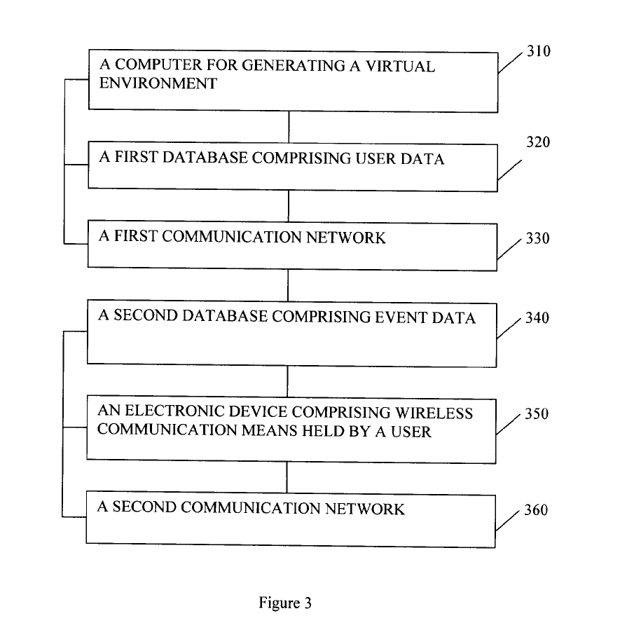

FIG. 3 shows a plurality of elements comprises in an interactive system. The system comprises at least a computer 310, generating a virtual environment wherein a user enters his information and preferences, to create an associated virtual entity. These information and preferences are stored on a first database 320, including the preferences associated with the user and the virtual entity. A first communication network 330 is used to operatively link the first database 320 and the computer 310. A second database 340 comprises data associated with an event which is attended by a plurality of users. At least one electronic device 350 comprising wireless communication means held by a user is used to send event data to the user. A second communication network 360 operatively linked to the second database 340 and the electronic device 350 is used to send data to the user.

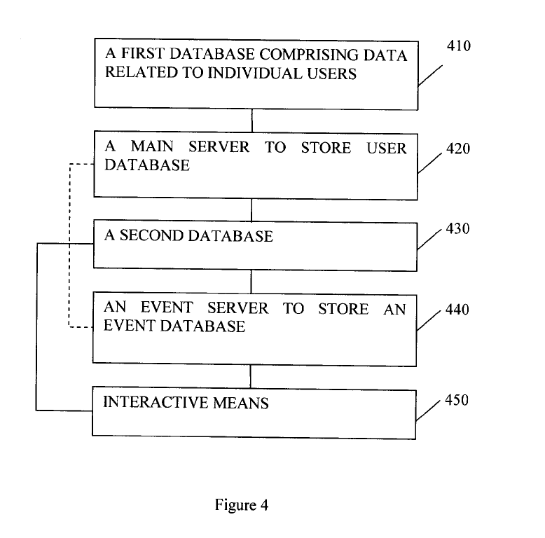

FIG. 4 shows a plurality of elements comprises in an event based interactive system allowing an operator of the system to communicate with individual users interested in the event. The system comprises a first user database 410 which is stored on a main server 420. A second database 430 comprises data related to an event which is stored on an event database 440. The user may receive information, offer or other services, during the event or even previously and after, through an interactive means 450.

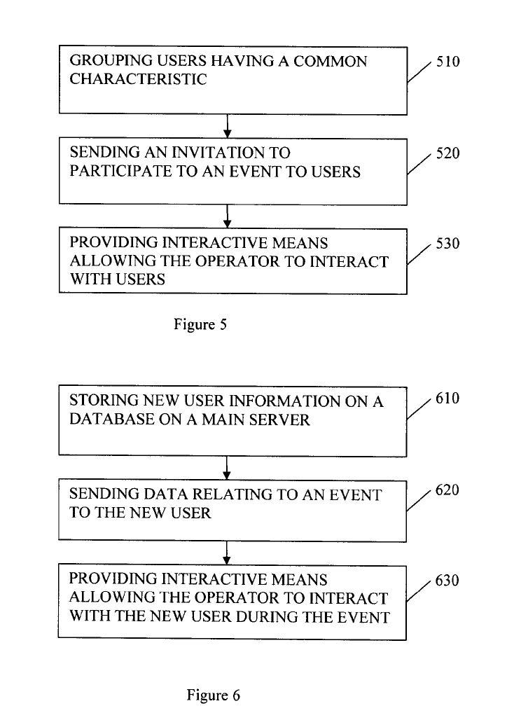

FIG. 5 shows a plurality of steps to operate an interactive communication method allowing an operator of the method to communicate with users of a database containing data related to users stored on a main server. In the first step 510, users having a common characteristic are grouped. In the second step 520, invitations are sent to users of the group previously created 510 to participate to an event. Following an agreement from users, the operator of the method can interact with the authorized users through interactive means 530.

FIG. 6 shows a plurality of steps to operate an event based method allowing an operator of the method to add new users interested in the event to an existing database stored on a main server. In a first step 610, the information of a new user is stored on a database on a main server. Secondly, data related to an event is sent to the new user 620. Following an agreement from users, the operator of the method can interact with the authorized new users through interactive means 630.

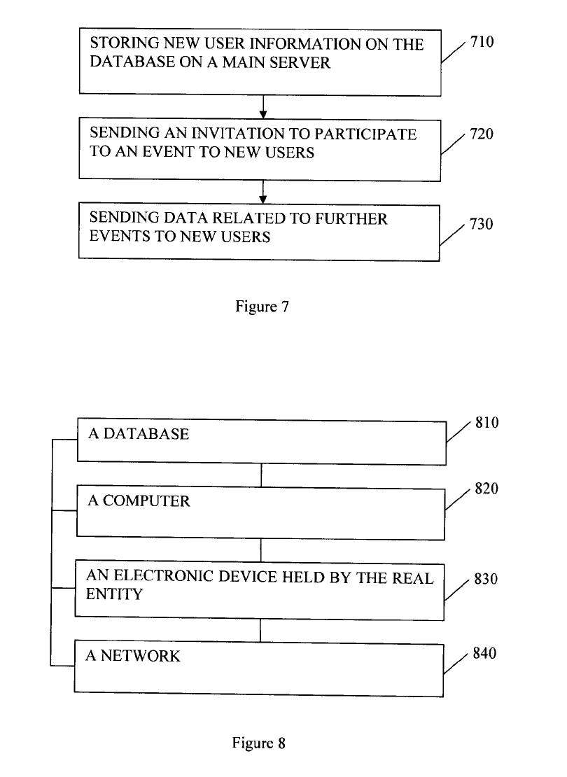

FIG. 7 shows a plurality of steps to operate an event based method allowing new users interested to participate to an event to be added to an existing database stored on a main server. In a first step 710, the information of a new user is stored on a database on a main server. Secondly, invitations are sent to new 720 to participate to an event. Following an agreement from users, data related to further events is sent to new users 730.

FIG. 8 shows a plurality of elements comprises in a system for interactively linking a real entity and a corresponding virtual entity thereof. The system comprises a database 810 comprising data about the real and the virtual entity. A computer 820 is provided for generating a virtual environment wherein the virtual entity is virtually located. A network 840 is operatively linking the database 810, the computer 820 and an electronic device 830 held by the real entity.

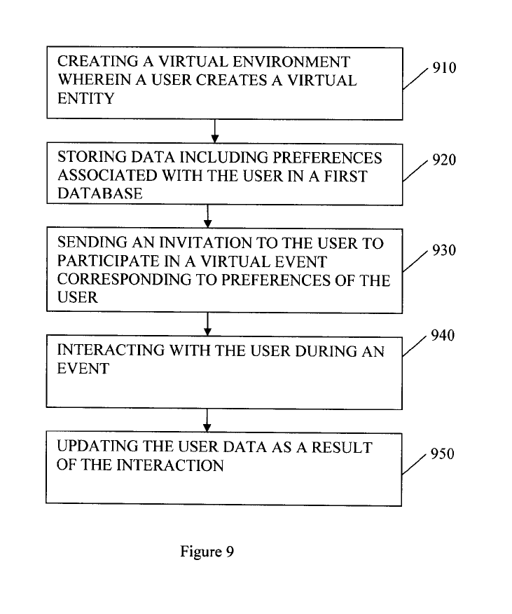

FIG. 9 shows a plurality of steps to operate an interactive communication method. In a first step 910, a virtual environment is created wherein a user create a virtual entity. In a second step 920, the data associated with the user, including his preferences, is stored in a first database. In a third step 930, invitations are sent to users to participate to an event corresponding to their preferences. Following an agreement of the user, it is possible to interact with the user 940. Finally, the user data is updated 950 after the interaction of the user.

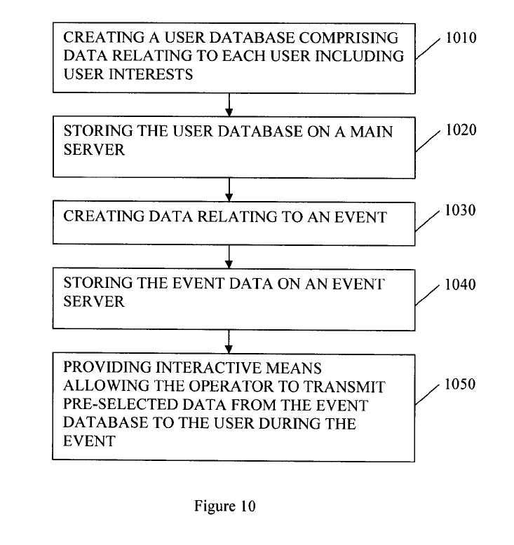

FIG. 10 shows a plurality of steps to operate an event based interactive communication method allowing an operator of the method to communicate with a plurality of users interested in an event. In a first step 1010, data related to each user including user interest is stored on a database. Secondly, the user database is stored on a main server 1020. In a third step 1030, data related to an event is created. In the next step 1040, data related to the event is stored on an event server. In a further step 1050, an operator transmits pre-selected data from the event database to the user during an event through interactive means.

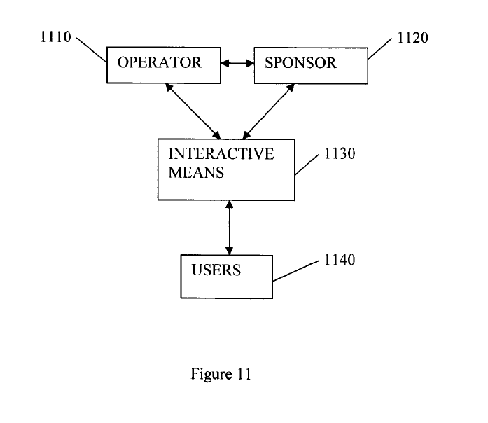

The FIG. 11 shows the relations between the operators 1110, the sponsors 1120 and the users 1140. Interactive means 1130 are used to exchange data between users and operators or users.

In an embodiment of the present invention, supposing that a user has an interest in music, an invitation may be sent to see a concert or a show at an event such as the Montreal Jazz Festival (Festival International de Jazz de Montréal™). At the show or previously, the user may receive applications or information on his/her network-enabled device. He/she may get rebates for food, drinks or else. Furthermore, the user may receive points or a rebate to use in a music store or to concerts of a particular artist or producer that are accessible only to the community that has accepted the invitation for the show.

Another example of an embodiment of the present invention would be a day of shopping at a Costco™ warehouse. One or more wireless communication node (access point, router, repeater . . . ) is disposed in the store to provide a wireless access. An event server having the data related to the event is also connected to this network. When a user enters the Costco™ store, supposing that this user has previously installed an application related to this event, he/she may consult what are the activities and offers available. The user may consult and/or download recipes for a product that he/she wants to buy. Also, instead of filling a paper form to get an article that is not accessible on the floor (for example jewels, televisions, etc . . . ), the user may choose the article on his/her wireless network-enabled device and the article will be automatically added and preferably prepared when he/she gets to the cashier. Furthermore, he/she may get rebates or promotional products because he/she is a member of the Costco™ community.

The users of the present invention may also participate in a virtual event. A first example is a virtual event where many users, operators or sponsors may participate. The participants may create a virtual entity having their physical characteristics or others. There may be messages or offers of the sponsors of the event and even prices that the user can win.

A virtual event may also be a virtual exchange place where users may participate with an avatar and give their opinion on a particular topic provided by a sponsor.

For example, if, when in the virtual environment, the user's avatar goes to a café and orders a latte, then this information can be stored onto the main database for future use. Continuing the example, should the user, enter into a real life café which is also linked to the system of the present invention, then a compatible device such as a Bluetooth™ transceiver, linked to the main database via the Internet, could detect the device (e.g. his Bluetooth™ enabled cellular phone) carried by the user. Then the device of the user could transmit to the device of the real life café that the user generally orders lattes in cafés. Accordingly, the clerk, using this information, could automatically offer a latte to the user or offer a rebate for the latte.

Still, pursuing the same example, should the user decide to order an espresso instead, this new information could be entered and transferred to the database so that the next time the user will go into a café, the clerk could offer the user either a latte or an espresso.

Another example would be when users of a common community want to exchange information or speak together, they can exchange their phone numbers. These phone numbers could be stored in the main database so that they could be retrieved by the users via their respective devices. They could then call each other.

In yet another example, suppose that a user has a wish-list of books and/or DVDs stored on an on-line store Web site. Suppose also that a bookstore is connected to the system and therefore has the appropriate transceivers, then if the user enters that bookstore, he/she could be offered some of his/her wished for books should they be on sale. Moreover, should the user buy in the bookstore one of the books from his/her wish-list, then the wish-list could be automatically updated accordingly.

The above-recited examples are by no means limitative in nature. They only show how the system of the present invention can use information gathered in a virtual environment to execute an action in the real world and vice versa. The skilled addressee will readily understand that the present invention could be extended any other applicable situations.

In a nutshell, in an embodiment of the present invention, the system generally stores, in a main database, information gathered by a user and also information gathered in a virtual environment or world. Thus, using the system of the present invention, the information a user would gathered, for example, while surfing on the Internet, would be available to him/her, via a preferably handheld, wireless and network-enabled device, while talking to a friend in a café having a compatible wireless access. Conversely, the information that the user would have gathered while talking to his friend, a phone number for example, would be available to him/her while sending a e-mail or updating his/her contact list.

The system of the invention therefore comprises at least one database and preferably more than one for redundancy and quality of service purposes. The databases are also preferably placed on remotely accessible servers using the Internet or other public or private network.

The system also comprises a plurality of network-enabled and preferably portable devices such as cellular phones, pocket PCs, PDA's, laptops, personal e-mailing system (e.g. Blackberry™) which can be linked to the Internet directly via wire or wireless access or via public or private phone networks. Other media to access the Internet or such other networks are also possible and implicitly included in the present invention since the system is not so limited.

The system of the present invention also preferably comprises a plurality of computers or similar devices adapted to generate virtual environments. Understandably, the computers or similar devices are also adapted to be connected to the Internet with wire or wirelessly.

By being all connected or at least connectable to the Internet, both the network-enabled devices and the computers can access the databases wherein information about users is stored.

Understandably, a portion of the information stored on the database can be private while the rest is public or at least accessible to others.

Therefore, when the network-enabled devices can further communicate with each other, using for example Bluetooth™, the devices can detect that the other device is linked to an account on the same database and can accordingly, retrieve the public information about the user having or carrying the device.

For example, if two users have network-enabled cellular phones which are also Bluetooth™ enabled and are within communication range of each other, then the cellular phone of each user can access the common database and retrieve the public information about the other user. This information can afterward be used, for instance, to start a discussion.

The above examples could advantageously be used in conferences or in other events where numerous people sharing similar interests meet. Being able to retrieve information about an interlocutor for immediate use or for future use would be greatly beneficial.

Understandably, the present invention could be used in a multitude of circumstances. Still, the present invention provides users a common database wherefrom both the users and operators of the method can store, retrieve and share information.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An interactive system comprising:
a. at least one computer for generating a virtual environment wherein a user creates a virtual entity associated to said user;
b. a first database comprising data including preferences associated with said user and said virtual entity;
c. a first communication network operatively linking together said first database and said at least one computer;
d. a second database comprising data associated with an event which is attended by a plurality of said users.

2. An interactive system as claimed in claim 1, wherein said event is held in said virtual environment.

3. An interactive system as claimed in claim 1, wherein said event is held in real life.

4. An interactive system as claimed in claim 1 further comprising:
a. at least one electronic device comprising communication means operated by said user;
b. a second communication network operatively linking together said second database and said at least one electronic device.

5. An interactive system as claimed in claim 4, further comprising means to operatively link together said first communication network and said second communication network.

6. A event based interactive system allowing an operator of the system to communicate with individual users interested in said event, said system comprising:
a. a first database comprising data related to said individual users;
b. a main server to store said user database;
c. a second database comprising data related to said event;
d. an event server to store said event database;
e. interactive means allowing said operator to interact with said user during said event.

7. The system of claim 6, wherein said interactive means is a wireless communication enabled device.

8. The system of claim 7, wherein said interactive means further comprise means to push from said event server at least a portion of said event data to said wireless device.

9. The system of claim 6, wherein said interactive means communicate with said event server.

10. The system of claim 6, wherein said interactive means communicate with said event server and said main server.

11. An interactive communication method allowing an operator of the method to communicate with users of a database containing data related to said users stored on a main server, said method comprising the following steps:
a. grouping said users having a common characteristic;
b. sending an invitation to participate to an event to said users;
c. providing interactive means allowing said operator to interact with said user.

12. An event based method allowing an operator of the method to add new users interested in said event to an existing database stored on a main server, said method comprising the following steps:
a. storing said new user information on said database on said main server;
b. sending data relating to said event to said new user;
c. providing interactive means allowing said operator to interact with said new user during said event.

13. An event based method allowing new users interested to participate to event to be added to an existing database stored on a main server, said method comprising the following steps:
a. storing said new user information on said database on said main server;
b. sending an invitation to participate to said event to said new users;
c. sending data related to further events to said new user.

14. A system for interactively linking a real entity and a corresponding virtual entity thereof, said system comprising:
a. at least one database comprising data about said real entity and said virtual entity;
b. at least one computer for generating a virtual environment wherein said virtual entity is virtually located;
c. at least one electronic device held by said real entity;
d. a network operatively linking together said at least one database, said at least one computer and said at least one electronic device;
whereby said real entity can store and/or retrieve said data from said at least one database.

15. An interactive communication method comprising;
a. creating a virtual environment wherein a user creates a virtual entity;
b. storing data including preferences associated with said user in a first database;
c. sending an invitation to said user to participate in a virtual event corresponding to at least one of said preferences;
d. interacting with said user during said event;
e. updating said user data as a result of said interaction.

16. An event based interactive communication method allowing an operator of the method to communicate with a plurality of users interested in said event, said method comprising the following steps:
a. creating a user database comprising data relating to each said user including user interests;
b. storing said user database on a main server;
c. creating data relating to said event;
d. storing said event data on an event server;
e. providing interactive means allowing said operator to transmit pre-selected data from said event database to said user during said event.

17. The method of claim 16, wherein said pre-selected data varies as a function of time.

18. The method of claim 16, wherein said pre-selected data varies as a function of said user data.

19. The method of claim 16, wherein said pre-selected data varies as a function of time and as a function of said user data.

20. The method of claim 16, further comprising grouping said event data by themes and/or topics.

21. The method of claim 16, further comprising grouping said event data by user interests.

22. The method of claim 21, further comprising sending an invitation to a plurality of users having similar interests to participate in said event.

23. The method of claim 16, wherein said user data are updated following the participation to an event.

24. The method of claim 16, wherein said interactive means comprise a wireless network-enabled device.

25. The method of claim 24, further comprising downloading event data on said wireless device during said event.
